(19) United States
(12) Patent Application Publication
(10) Pub. No.: US 2026/0100010 A1
(43) Pub. Date: Apr. 9, 2026

(54) Depth-Guided Text-Based Editing of 3D Neural Radiance Fields

(71) Applicant: Adobe Inc., San Jose, CA (US)

(72) Inventors: Sara Rojas Martinez, Thuwal (SA); Julien Philip, London (GB); Kai Zhang, San Jose, CA (US); Sai Bi, San Jose, CA (US); Fujun Luan, San Jose, CA (US); Kalyan Sunkavalli, San Jose, CA (US)

(21) Appl. No.: 18/908,375

(22) Filed: Oct. 7, 2024

(51) Int. Cl. G06T 19/20; G06T 5/60; G06T 5/70; G06T 15/08

(52) U.S. Cl. CPC G06T 19/20; G06T 5/60; G06T 5/70; G06T 15/08; G06T 2207/10024; G06T 2207/10028; G06T 2207/20076; G06T 2207/20081; G06T 2207/20084; G06T 2207/20104; G06T 2207/30196; G06T 2210/56; G06T 2219/2012

(57) ABSTRACT

Techniques for depth guided text-based editing of 3D neural radiance fields are provided. A method includes receiving input 2D images corresponding to views of a target and generating a 3D representation from the input 2D images. The 3D representation includes points forming a point cloud, where each point has a color and density value. The method also includes accumulating the color and density values to generate a volumetric 3D scene having a geometry, extracting distance maps from the volumetric 3D scene based on the geometry, and generating a plurality of masks associated with the target for each view. The method also includes aggregating the masks into the volumetric 3D scene using the geometry, providing the input 2D images, the masks, and the distance maps to a diffusion model, and modifying an appearance of the target in the volumetric 3D scene by providing a text command to the diffusion model.

### TECHNICAL FIELD

This disclosure generally relates to three-dimensional (3D) scene editing. More specifically, but not by way of limitation, this disclosure relates to depth guided text-based editing of 3D neural radiance fields (NeRF).

### BACKGROUND

NeRF networks can generate views of a 3D scene from a set of input two-dimensional (2D) images. NeRF networks can generate, given any view coordinates (e.g., an input spatial location and viewing direction), a view of the 3D scene. Additionally, 2D diffusion models are used for image synthesis and text-based editing of 2D images. For example, 2D diffusion models can generate or edit images using text prompts, inpaint masked regions in images, or edit images following user instructions. Given the capabilities of these 2D diffusion models, they have been utilized to edit 3D NeRF scenes. However, editing individual 2D images of the 3D NeRF scene using a 2D diffusion models produces inconsistent results that require different forms of regularization and/or rely on mechanisms of NeRF optimization to resolve. As one example, using a 2D diffusion model to edit 3D NeRF scenes produces a result that suffers from errors in geometry, blurry textures, and poor text alignment. As such, there is a need in the art for improved techniques for 3D scene editing.

### SUMMARY

The present disclosure relates to depth guided text-based editing of 3D NeRFs. In particular, the present disclosure describes techniques for depth guided text-based editing of 3D NeRFs using a set of input 2D images, a point-based scene representation model, and a diffusion model to generate a modified 3D scene. A scene editing system receives input 2D images corresponding to views of a target disposed in an environment and a request to modify a specific region of the 2D images (e.g., a region of interest associated with the target in the environment). The scene editing system generates a 3D representation from the input 2D images by applying a scene representation model. The scene representation model receives the input 2D images, where each input 2D images includes a set of pixels and each pixel value is defined by a position and direction corresponding to the view angle in the environment. The scene representation model generates a 3D representation from the input 2D images. The 3D representation may be a NeRF. The NeRF includes a set of points forming a point cloud and each point is defined by a color value and a density value. The color values and density values may be accumulated in a volume rendering process to generate a volumetric 3D scene having a scene geometry, where the geometry is associated with an expected distance per pixel value for any given viewpoint in the volumetric 3D scene (e.g., any NeRF viewpoint). The distance per pixel values may be referred to as distance maps. In conjunction with generating the volumetric 3D scene, masking is performed across the views of the target and region of interest. The masks are aggregated into the volumetric 3D scene utilizing the geometry.

The input 2D images, masks, and distance maps are then provided to a diffusion model. The diffusion model also receives an input command containing a request to modify an appearance of the target associated with the region of interest. The diffusion model can include a denoising diffusion probabilistic model (DDPM) that performs a series of denoising operations on the volumetric 3D scene to modify an appearance of the target based on the region of interest defined by the masks. Since the diffusion model is conditioned on the set of masks, the diffusion model may adjust the diffusion operations (e.g., denoising operations) to account for the regions of interest. In particular, the diffusion model applies a blended diffusion technique where a series of denoising operations are applied to full noised image latents (e.g., the volumetric 3D scene), and after each denoising operation, the denoised result is replaced by the noised input latents (e.g., the original volumetric 3D scene) in the regions outside the region of interest defined by the set of masks. This process results in a modified 3D scene that retains the original input 2D images outside the region of interest defined by the set of masks but generates the edits to the masked regions that are consisted with input text command. The scene editing system transmits the modified 3D scene representation to a user display device for viewing.

Various embodiments are described herein, including methods, systems, non-transitory computer-readable storage media storing programs, code, or instructions executable by one or more processing devices, and the like. These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Features, embodiments, and advantages of the present disclosure are better understood when the following Detailed Description is read with reference to the accompanying drawings.

FIG. 1 is an example of a computing environment for generating, based on input images and using scene representation model and a diffusion model, a modified 3D scene, according to certain embodiments disclosed herein.

FIG. 2 is an example method for generating, based on input images and using scene representation model and a diffusion model, a modified 3D scene, according to certain embodiments disclosed herein.

FIG. 3 is an example method for generating final masks based on input images, according to certain embodiments disclosed herein.

FIG. 4 depicts an example of a modified 3D scene utilizing depth-guided text-based editing of 3D NeRFs.

FIG. 5 depicts an example of a comparison between a modified 3D scene utilizing depth-guided text-based editing of 3D NeRFs as compared to conventional techniques.

FIG. 6 is an example of a computing system that performs certain operations described herein, according to certain embodiments described in the present disclosure.

FIG. 7 is an example of a cloud computing system that performs certain operations described herein, according to certain embodiments described in the present disclosure.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The words “exemplary” or “example” are used herein to mean “serving as an example, instance, or illustration.” Any embodiment or design described herein as “exemplary” or “example” is not necessarily to be construed as preferred or advantageous over other embodiments or designs.

NeRF based techniques enable reconstruction and rendering of 3D environments with case and visual quality that was previously not possible with traditional 3D representation techniques. For example, traditional 3D representation techniques, such as textured meshes, explicitly decouple the geometry and the appearance of targets within the 3D scene. Users can edit the 3D scene to produce visually compelling results, but given the decoupled geometry and appearance, editing the 3D scene using conventional techniques requires significant time and skill. Simply combining these conventional techniques (e.g., textured meshes) with NeRF representations does not improve the results because NeRFs lack explicit representations of surfaces and appearances. Additionally, techniques for image synthesis and image editing can utilize 2D diffusion based generative models. These 2D diffusion based generative models can generate (or edit) images using text prompts, inpaint masked regions in images, or edit images following user instructions. For example, a 2D diffusion based generative models can be used to enable the generation and editing of content conditioned on spatial guidance signals such as depth, edges, and segmentation maps.

Combining NeRF techniques and 2D diffusion based generative models has enabled improvements to scene editing. However, editing individual images of the 3D scene using 2D diffusion based generative models gives rise to a problem of inconsistent results. The inconsistent results require different forms of regularization and/or relying on the NeRF optimization to resolve, which can be time consuming and computationally intensive. Additionally, techniques of regularization still can suffer from errors in geometry, blurry textures, and poor text alignment. As such, there is a need in the art for improved techniques for editing 3D scenes using NeRFs and 2D diffusion based generative models.

Certain embodiments described herein address the limitations of scene editing systems by providing a depth guided text-based editing of 3D NeRFs using a set of input 2D images, a scene representation model, and a diffusion model to generate a modified 3D scene. A scene editing system is typically a network-based computing system including network-connected servers configured to offer a service (e.g. via a website, mobile application, or other means) allowing end users (e.g., consumers) to interact with the servers using network-connected computing devices (e.g. personal computers and mobile devices) to upload multiple 2D images of a target (e.g. a vehicle, furniture, a house, merchandise, etc.) from different views corresponding to multiple camera viewing angles. The requests can also include text-based commands received from a user to edit the target within the 3D scene rendered from the set of input 2D images in a way that produces multiview-consistent results. Embodiments described herein utilize the geometry of a NeRF representation to unify the 2D image edits to improve the consistency of individual 2D image edits thereby leading to consistent, realistic, detailed editing results.

In particular, the techniques described herein utilize the geometry of the NeRF scene to improve the consistency of edits to each individual 2D input image and use a 2D diffusion model conditioned on the geometry (e.g., distance maps extracted from the NeRF representation) for text editing. Conditioning the 2D diffusion model on the distance maps improves the geometric alignment of edited images to produce a high-quality edited NeRF scene (e.g., modified 3D scene). The techniques described herein provide a modified 3D scene with cleaner geometry and more detailed textures as compared to conventional techniques. Embodiments of the present disclosure that utilize 2D diffusion models conditioned on the NeRF geometry also enable a broader spectrum of fine-grained NeRF modification capabilities, encompassing both edge-based scene alterations and insertion of objects into the scene. Integration of the NeRF geometry with the 2D diffusion model also enhances the controllability of scene editing thereby enabling general text-based editing of a scene. Additionally, embodiments of the present disclosure that utilize the NeRF geometry and diffusion models enable faster NeRF convergence thereby saving computational resources.

The following non-limiting example is provided to introduce certain aspects of the present disclosure. In this example, a scene editing system implements a scene representation model and a diffusion model. The scene editing system receives input 2D images captured of a target (or a set of targets) disposed in an environment from multiple camera viewing angles. The 2D images are defined by pixels and each pixel is associated with a position and direction corresponding to the viewing angle. The scene editing system also receives a request in the form of a text command to edit or modify a region of interest associated with the target in the environment. As an example, the target is a vehicle. The input images may be received from a user computing device (e.g., a mobile device, a tablet device, a laptop computer, or other user computing device). For example, a user of the user computing device captures images of the vehicle from multiple locations and/or camera viewing angles and the text command could be a request to edit the tires (e.g., region of interest) of the vehicle.

Continuing on with this example, the set of input 2D images may be denoted as {I₁, I₂, I₃, . . . , Iₘ} and where the pixels of the images may include a corresponding camera calibration (e.g., camera viewing angle) and position (e.g., spatial location). The set of input 2D images may be received as input by the scene editing system. Using the scene representation model, a 3D representation can be constructed based on the set of input 2D images, where the 3D representation is a NeRF. The NeRF can include a set of points forming a point cloud where each point is defined by a color (e.g., RGB) value and a density value. The scene representation model can accumulate these color values and density values and perform a volumetric rendering on the accumulated points to generate a volumetric 3D scene, which enables the rendering of novel views. Additionally, the volumetric 3D scene can be defined by a geometry, where the geometry is an expected distance per pixel for any given viewpoint in the volumetric 3D scene. The geometry is denoted by distance maps for the input viewpoints as {D₁, D₂, D₃, . . . , Dₘ}.

In conjunction with generating the volumetric 3D scene, and based on the text command, a set of masks can be generated. The masks can correspond to the target and the region of interest associated with the text command. However, the masks may have inaccuracies and/or be inconsistent with each other when applied to the volumetric 3D scene. To rectify these issues, the masks are aggregated in 3D using the geometry of the volumetric 3D scene. In particular, each pixel of the initial masks are unprojected into the volumetric 3D scene using the distance maps to generate a set of 3D mask points. Each mask point is assigned a confidence value representing a probability that the 3D mask point is within a proximity to a surface of the target within the environment. When the confidence value of a 3D mask point exceeds a predefined visibility threshold value, the point cloud of the 3D representation is updated to include the 3D mask point. Conversely, when the confidence value of a 3D mask point does not exceed the predefined visibility threshold value, the 3D mask point is discarded (e.g., outlier points that lie outside a specified sphere centered on the target are removed). The 3D mask points from the updated point cloud are projected back into the initial mask and a guided filtered is employed to filter the masks (e.g., guided by the RGB values of the input 2D images). The guided filter can be derived from a local linear model and can utilize a determined context from a guidance image (e.g., the input 2D images) to remove noise in the input image while preserving clear edges. This results in a set of clean, occlusion-aware final masks that are view-consistent. These final masks are denoted as {M₁, M₂, M₃, . . . , Mₘ}.

The input 2D images, {I₁, I₂, I₃, . . . , Iₘ}, the distance maps, {D₁, D₂, D₃, . . . , Dₘ}, and the final masks {M₁, M₂, M₃, . . . , Mₘ}, are then provided to a diffusion model. The diffusion model includes a DDPM that performs a series of denoising operations modify an appearance of the target in the volumetric 3D scene. In particular, the diffusion model is conditioned on the distance maps (e.g., the distance maps are converted to per-view disparities for the diffusion model) and the final masks corresponding to the target and a region of interest. The diffusion model adjusts the diffusion operations (e.g., denoising operations) based on this conditioning to account for the regions of interest. More specifically, the diffusion model applies a blended diffusion technique where a series of denoising operations is applied to full noised image latents (e.g., the volumetric 3D scene), and after each denoising operation, the denoised result is replaced by the noised input latents in a background region of the input 2D images outside the region of interest defined by the set of masks. Utilizing this blended diffusion technique by the diffusion model ensures that the modified 3D scene retains the original input images outside the region of interest defined by the set of masks, but generates the edits to the masked regions that are consisted with input text command. The blended diffusion technique employed by the diffusion model is denoted as:

$${I}_{k}^{e} = B l e n dedDiffusion ( ControlNet ( {I}_{k} , {D}_{k} ) , {M}_{k} ) .$$

The modified 3D scene generated as output achieves a multi-view consistent text-based edit of the volumetric 3D scene. In other words, given a target and a region of interest defined by a text command, the techniques described herein achieve complex edits such as material, texture, or content modifications. Additionally, conditioning the diffusion model on the NeRF geometry produces edits that more closely match the text prompts, require fewer inferences from the diffusion model, and converge more quickly. The techniques described herein allow for use of different types of guidance, such as canny edges or intermediary meshes, thus also broadening its applications.

### Example Systems and Methods for Depth-Guided Text-Based Editing of 3D Neural Radiance Fields

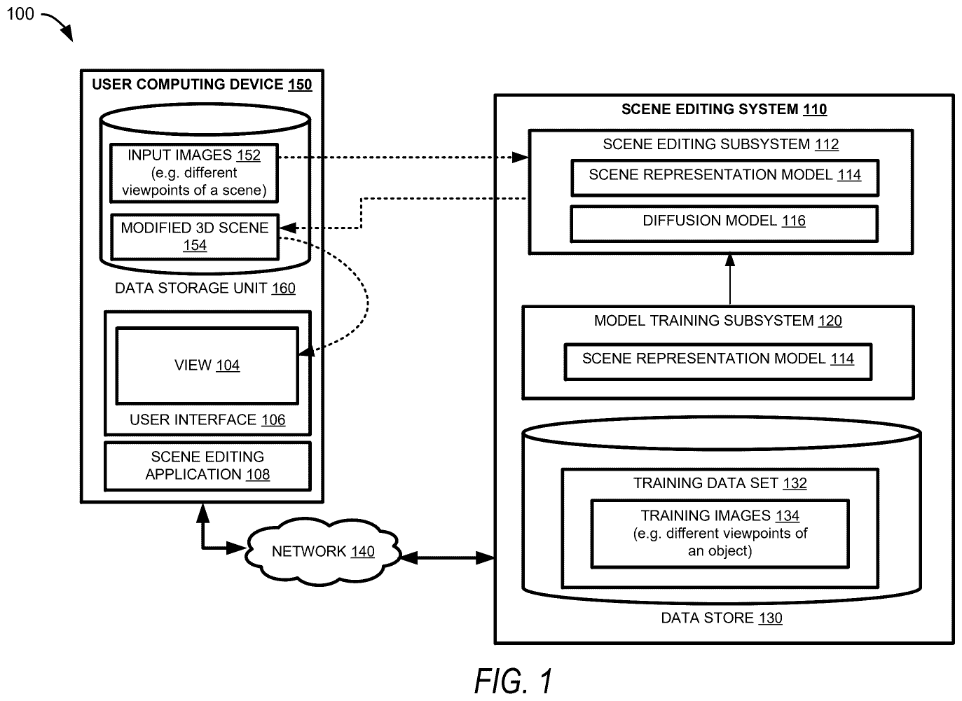

Referring now to the drawings, FIG. 1 is an example of a computing environment 100 for generating, based on input 2D images and using scene representation model and a diffusion model, a modified 3D scene. The computing environment 100 includes scene editing system 110, which can include one or more processing devices that execute a scene editing subsystem 112 and a model training subsystem 120. In certain embodiments, the scene editing subsystem 112 is a network server or other computing device connected to a network 140.

The scene editing subsystem 112 applies a scene representation model 114 and a diffusion model 116 to input images 152 received from a user computing device 150 (or other client system) to generate a modified 3D scene for display on user computing device 150 as view 104. For example, the scene editing subsystem 112 can receive or otherwise access input images 152, which may be denoted as {I₁, I₂, I₃, . . . , Iₘ}. The input images 152, in some instances, are captured by the user computing device 150 and provide different views of a target in an environment. The target may be an object, a person, an animal, etc. Additionally, the input images 152 can be defined by a set of pixels where each pixel value may be represented in five dimensions for use by the scene editing subsystem 112. For example, a position value may represent a location of the pixel in three dimensions (e.g., (x,y,z) dimensions), and a direction value may represent a view angle associated with the pixel in two dimensions (e.g., (θ,φ) dimensions) with respect to the camera viewing angle.

In some instances, the input images 152 are provided to the scene editing subsystem 112 by the user computing device 150 executing a scene editing application 108. In certain examples, a user uploads the input images 152 and the user computing device 150 receives the input images 152 and transmits, via the network 140, the input images 152 to the scene editing subsystem 112. In certain examples, the user uploads or otherwise selects the input images 152 via a user interface 106 of the user computing device 150 (e.g., using the scene editing application 108). In some instances, the scene editing application 108 receives and communicates the selection of the input images 152 to the scene editing subsystem 112 via the network 140. In some instances, the scene editing system 110 provides, for download by the user computing device 150, the scene editing application 108. In some instances, the scene editing application 108 displays a request to upload or otherwise select a set of input images 152, which could read “Please upload/select images.” The scene editing application 108 receives a selection of the input images 152.

In some instances, the scene editing subsystem 112 receives the set of input images 152 corresponding to a set of views of the target and a request to display a modified 3D scene 154 that includes the target with a desired appearance modification in a region of interest associated with the target. The scene editing subsystem 112 and/or the scene editing application 108 can render multiple views of the modified 3D scene 154 using a volume rendering process for display on user interface 106. In some instances, the user inputs a view coordinate for display of a view 104 of the modified 3D scene 154 corresponding to the view coordinate. For example, the view coordinate defines a position and orientation of a camera within the modified 3D scene 154 for display of the view 104.

Staying with FIG. 1, after the input images 152 are received by the scene editing system 110, the scene editing subsystem 112 executes the scene representation model 114 and the diffusion model 116 on the input images 152. Executing the scene representation model 114 includes generating a 3D representation from the input images 152. Each input image can be defined by pixel values where each pixel has a position and a direction associated with a camera viewing angle (e.g., view). The scene representation model 114 can receive the input images 152 and generate a 3D representation of the input images 152, where the 3D representation includes points that form a point cloud. Each point in the point cloud can be defined by a color value and a density value. In some examples, the 3D representation can be NeRF. Additionally, the scene representation model 114 can accumulate the color values and density values of each point in the point cloud and perform a volumetric rendering on the points to generate a volumetric 3D scene having a geometry. The geometry of the volumetric 3D scene refers to an expected distance per pixel value for any view in the volumetric 3D scene and may be denoted as distance maps for the input views as {D₁, D₂, D₃, . . . , Dₘ}.

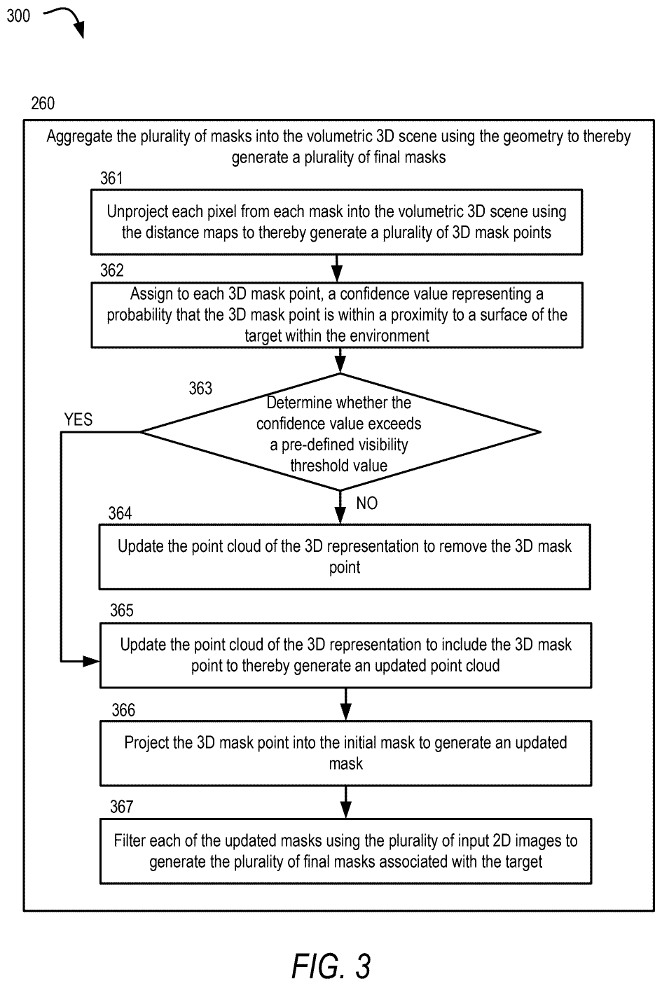

In conjunction with generating the volumetric 3D scene masking can be performed based on the target in the environment and a region of interest associated with the text command. The masks can have a set of pixels and can be aggregated in 3D using the geometry of the volumetric 3D scene. Further details describing the process for generating the masks are described below in relation to FIG. 3. The final masks provided as input to diffusion model 116 may be denoted as: {M₁, M₂, M₃, . . . , Mₘ}.

The one or more processing devices of the scene editing system 110 can further execute a diffusion model 116 conditioned on the distance maps generated by the scene representation model 114. One type of diffusion model that may be used is ControlNet, which is a neural network architecture that can be utilized to enhance large pretrained text-to-image diffusion models with spatially localized, task-specific image conditions, such as edge maps and depth maps. Diffusion model 116 may receive, as input, the input images 152, denoted as {I₁, I₂, I₃, . . . , Iₘ}, the distance maps generated by the scene representation model 114, denoted as {D₁, D₂, D₃, . . . , Dₘ}, and the final masks corresponding to the target and a region of interest, denoted as {M₁, M₂, M₃, . . . , Mₘ}. The diffusion model can also receive the text command with instructions to modify the target in the environment at the region of interest.

Diffusion model 116 can include a DDPM that can perform a series of denoising operations on the volumetric 3D scene to modify an appearance of the volumetric 3D scene. Additionally, the diffusion model 116 can be conditioned on the set of masks corresponding to the target and a region of interest, which enables the diffusion model 116 to adjust the diffusion operations (e.g., denoising operations) to account for the regions of interest. In particular, the diffusion model 116 can apply a blended diffusion technique where a series of denoising operations is applied to full noised image latents (e.g., the volumetric 3D scene), and after each denoising operation, the denoised result is replaced by the noised input latents in a background region of the input 2D images outside the region of interest defined by the final masks. Thus, utilizing this blended diffusion technique by the diffusion model 116 ensures that the modified 3D scene 154 retains the original input images 152 outside the region of interest defined by the final masks, but generates the edits to the masked regions that are consisted with input text command.

The one or more processing devices of the scene editing system 110 can further execute a model training subsystem 120 for training the scene representation model 114. For example, the scene editing system 110 transmits the modified 3D scene 154 to the user computing device 150 via the network 140 and the user computing device 150 stores the modified 3D scene 154 in the data storage unit 160. The scene editing system 110 further includes a data store 130 for storing data used in the generation of the modified 3D scene 154, such as the training data set 132. Training data set 132 can include training images 134 that may be images of a target from different viewpoints that may be accessed by the model training subsystem 120 to train the scene representation model 114. The training images 134 may also include the input images 152.

The scene editing subsystem 112 and the model training subsystem 120 may be implemented using software (e.g., code, instructions, program) executed by one or more processing devices (e.g., processors, cores), hardware, or combinations thereof. The software may be stored on a non-transitory storage medium (e.g., on a memory component). The computing environment 100 depicted in FIG. 1 is merely an example and is not intended to unduly limit the scope of claimed embodiments. One of the ordinary skill in the art would recognize many possible variations, alternatives, and modifications. For example, in some implementations, the scene editing system 110 can be implemented using more or fewer systems or subsystems than those shown in FIG. 1, may combine two or more subsystems, or may have a different configuration or arrangement of the systems or subsystems.

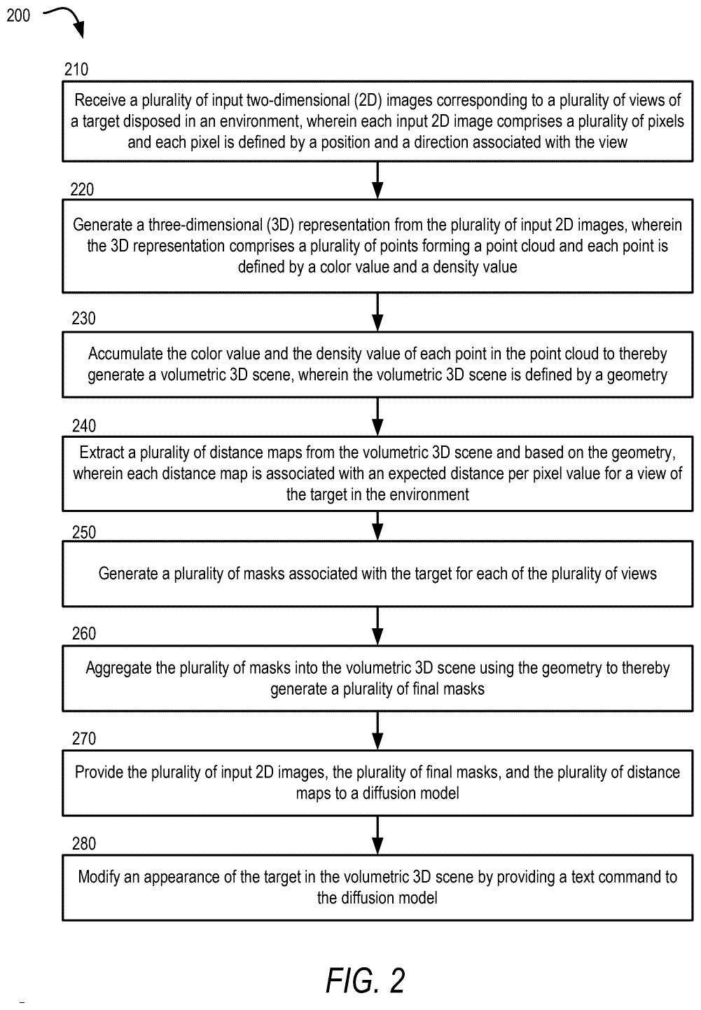

FIG. 2 is an example method for generating, based on input images and using a scene representation model and a diffusion model, a modified 3D scene. One or more computing devices (e.g., the scene editing system 110 or the individual subsystems contained therein) implement operations depicted in FIG. 2. For illustrative purposes, the method 200 is described with reference to certain examples depicted in the figures. Other implementations, however, are possible.

At block 210, the method 200 involves receiving input images 152 corresponding to a set of views of a target disposed in an environment. In an embodiment, the user computing device 150 transmits the input images 152 via the network 140 to the scene editing subsystem 112, as described in relation to FIG. 1. For example, the user captures, via a camera device of the user computing device 150, or otherwise selects from a data storage unit 160 of the user computing device 150, the input images 152. In certain embodiments, the user interacts with a scene editing application 108 to capture the input images 152 and/or otherwise select stored input images 152. The scene editing application 108 (or web browser application) is configured to transmit, to the scene editing system 110, a request to provide a view 104 of a modified 3D scene 154 based on the input images 152 responsive to receiving inputs from the user and to display the view 104 generated by the scene editing system 110. In some instances, the input images 152 correspond to one or more images of a target taken from various locations and/or camera viewing angles and the input images 152 can each have a set of pixel values. In some instances, each pixel value is defined by a position and a direction associated with the view. For example, a position value may represent a location of the pixel in three dimensions (e.g., (x,y,z) dimensions), and a direction value may represent a view angle associated with the pixel in two dimensions (e.g., (θ,φ) dimensions) with respect to the camera viewing angle that may be provided to the scene representation model.

At block 220, the method 200 involves generating, using a scene representation model 114, a 3D representation from the input images 152. The 3D representation includes a set of points that together form a point cloud. Each point in the point cloud may be defined by a color value (e.g., an RGB color value) and a density value. The 3D representation generated by the scene representation model can be a NeRF representation.

At block 230, the method 200 involves accumulating, using the scene representation model 114, the color value and the density value of each point in the point cloud. Further, a volumetric rendering process may be applied on the accumulated point cloud to generate a volumetric 3D scene. The volumetric 3D scene may be defined by a geometry associated with an expected distance per pixel value for any given view of volumetric 3D scene.

At block 240, the method 200 involves extracting, using the scene representation model, a set of distance maps from the volumetric 3D scene and based on the geometry. For instance, and as previously mentioned, the geometry of the volumetric 3D scene refers to an expected distance per pixel value for any view in the volumetric 3D scene and the distance maps may be denoted as {D₁, D₂, D₃, . . . , Dₘ}.

At block 250, the method 200 involves generating a plurality of masks associated with the target and a region of interest. In other words, for each view of the target in the environment, a mask of the target and the region of interest is generated. However, using conventional masking techniques, the initial masks generate can have inaccuracies and be inconsistent with each other.

To rectify these issues, block 260 of method 200 involves aggregating the initial masks in 3D using the volumetric 3D scene geometry. The process of generating the final masks is discussed in more detail in relation to method 300 of FIG. 3. Additionally, as previously mentioned, the final masks may be denoted as {M₁, M₂, M₃, . . . , Mₘ}.

At block 270, the method 200 involves providing the input images 152, denoted as Iₖ={I₁, I₂, I₃, . . . , Iₘ}, the distance maps generated by the scene representation model 114, denoted as Dₖ={D₁, D₂, D₃, . . . , Dₘ}, and the final masks corresponding to the target and a region of interest, denoted as Mₖ={M₁, M₂, M₃, . . . , Mₘ} to a diffusion model 116. Diffusion models such as diffusion model 116, and in particular DDPMs, transform a normal distribution (e.g., a distribution of input images) into a target distribution (e.g., a distribution of edited images) through a series of denoising operations that account for regions of interest (e.g., a portion of the image to be edited). For example, diffusion model 116 may use techniques known as stable diffusion to edit the input images 152 based on the text command, and in some examples, diffusion model 116 may be a U-net.

Editing the mask regions of the input images 152 using only techniques of stable diffusion may lead to a wide range of inconsistent changes across the edited images of the volumetric 3D scene. As such, techniques of the present disclosure utilize a diffusion model 116 conditioned on the volumetric 3D scene geometry in a process referred to as blended diffusion, which may be denoted as

$${I}_{k}^{e} = B l e n dedDiffusion ( C o n t r o l Net ( {I}_{k} , {D}_{k} ) , {M}_{k} ) , where \{ {I}_{k}^{e} \}$$

are the computed edited images. More specifically, the distance maps {Dₖ} are converted to per-view disparities and are provided to a ControlNet. The use of a ControlNet leverages the pretrained and powerful stable diffusion models by reusing their deep and robust encoding layers that are pretrained on millions or billions of images to learn a diverse set of conditional controls (e.g., conditional controls such as the per-view disparities derived from the distance maps).

At block 280, the method 200 involves modifying the appearance of the target in the volumetric 3D scene by providing a text command to the diffusion model. As mentioned previously, diffusion model 116 can include a DDPM to perform a blended diffusion technique on the input images 152 to compute the edited images,

$$\{ {I}_{k}^{e} \} .$$

More specifically, the diffusion model 116, which may be conditioned on the distance maps, {Dₖ}, can apply the denoising operations to the full noised image latents. After each denoising operation, the denoised result is replaced by the noised input latents (e.g., input images 152) in a background region of the input 2D images outside the region of interest associated with the final masks. In other words, a background region of the input 2D images outside the region of interest to be edited is copied or inserted back into the input 2D images. As a result, the final modified 3D scene that is transmitted for display on user interface 106 of user computing device 150 retains the original images outside the masked region but generates masked regions that are consistent with the text command.

FIG. 3 is an example method 300 for generating final masks based on input images 152, according to certain embodiments disclosed herein. Each of the initial masks generated for object masking can include a set of pixels, and at block 361, the method 300 involves unprojecting each pixel from each mask into the volumetric 3D scene using the distance maps. The process of unprojecting each pixel generates a set of 3D mask points.

At block 362, the method 300 involves assigning to each 3D mask point, a confidence value. The confidence value can represent a probability that the 3D mask point is within a proximity to a surface of the target within the environment.

Method 300 next involves decision block 363 where a determination is made as to whether the confidence value of each 3D mask point exceeds a pre-defined visibility threshold value. In the case where the confidence value exceeds the pre-defined visibility threshold value, the method 300 proceeds to block 365 where the point cloud of the 3D representation is updated to include the 3D mask point. This process generates an updated point cloud representing a view-consistent point cloud.

In the case where the confidence value does not exceed the pre-defined visibility threshold value the method 300 proceeds to block 364 where the 3D mask point is removed. In other words, outlier 3D mask points that lie outside a specified sphere centered on the object are removed.

Continuing on with method 300 and in the case where the point cloud is updated with the 3D mask point the method 300 proceeds to block 366 which involves projecting the 3D mask point into the initial mask. Projecting the 3D mask point into the initial mask generates an updated mask.

At block 367, method 300 involves filtering each of the updated masks using the plurality of input 2D images (e.g., guided by the RGB values of the input 2D images) to generate the final masks associated with the target in the region of interest. For instance, a guided filter can utilized that is derived from a local linear model. The guided filter can utilize a determined context from a guidance image (e.g., the input 2D images) to remove noise in the input image while preserving clear edges. This results in a set of clean, occlusion-aware final masks that are view-consistent. As previously mentioned, the final masks are denoted as {M₁, M₂, M₃, . . . , Mₘ} and may be provided as input to the diffusion model 116.

### Examples Results for Depth-Guided Text-Based Editing of 3D Neural Radiance Fields

As described herein, depth-guided text-based editing of 3D NeRFs can be used to adjust the diffusion steps to account for known regions. Specifically, blended diffusion technique where a series of denoising operations are applied to full noised image latents (e.g., the volumetric 3D scene), and after each denoising operation, the denoised result is replaced by the noised input latents (e.g., the original volumetric 3D scene) in the regions outside the region of interest defined by the set of masks. This process results in a modified 3D scene that retains the original input 2D images outside the region of interest defined by the set of masks but generates the edits to the masked regions that are consisted with input text command. As described herein, conditioning the image generation on the scene geometry is achieved by converting the NeRF distance maps {Dₖ} to per-view disparities and using the per-view disparities as conditioning for a diffusion model.

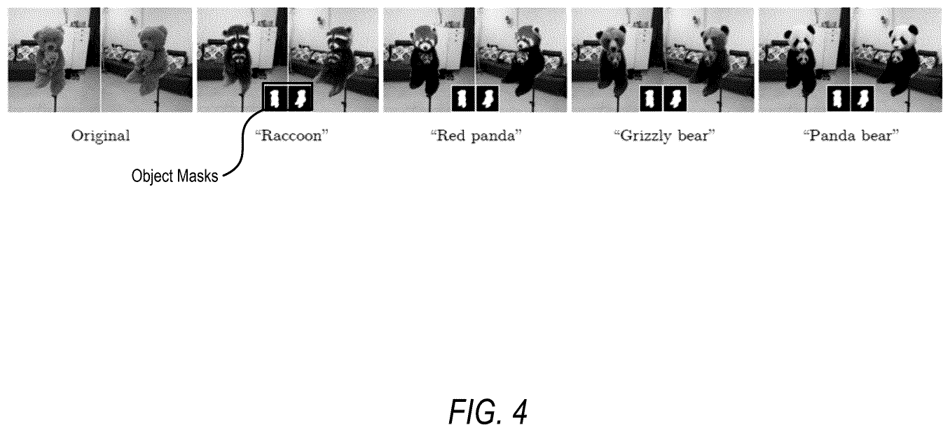

FIG. 4 depicts an example of a modified 3D scene utilizing depth-guided text-based editing of 3D NeRFs. As shown in FIG. 4, the results of the techniques described herein are displayed for a scene including a teddy bear. For the scene depicted in FIG. 4, the input views are displayed on the left column as the “Original” input view. Each subsequent column after the “Original” input view column illustrates the generated modified 3D scene based on varying text prompts such as “Racoon,” “Red Panda,” “Grizzly Bear,” and “Panda Bear.” Object masks are extracted depending on user-specified regions of interest of the scene. The object masks are rendered in the lower corner of the modified 3D scenes of FIG. 4. As shown in FIG. 4, the modified 3D scenes generated by the techniques described herein enable a realistic appearance that closely matches the input prompt with high-frequency texture details and consistent geometry. For example, the teddy bear is edited to a variety of different animals (e.g., raccoon, red panda, grizzly bear, panda bear). As illustrated by FIG. 4, the edited teddy bear has view-consistent edits and is highly realistic for multiple edits.

Although not shown in FIG. 4, the techniques described herein can also be used for 3D object insertion into the 3D scene as part of the 3D scene modification. Similar to the above-described techniques, object insertion can utilize the scene's NeRF geometry (e.g., depth maps). For instance, extraction of the scene's geometry can be performed using a technique known as truncated signed distance function (TSDF). Using the depth maps, new objects may be introduced into the scene, such as a 3D hat, added to the teddy bear.

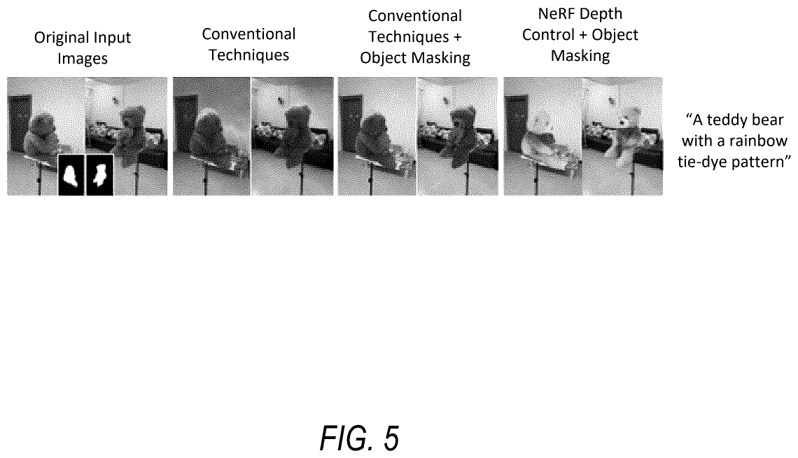

FIG. 5 depicts an example of a comparison between a modified 3D scene utilizing depth-guided text-based editing of 3D NeRFs as compared to conventional techniques. As shown by FIG. 5, original input images are illustrated by the column labeled as “Original Input Images.” The original input images of the teddy bear from FIG. 4 are shown in FIG. 5 and the text prompt is “a teddy bear with a rainbow tie-dye pattern.” The subsequent column after the Original Input Images column illustrates the modified 3D scene results using conventional techniques. As shown, edits to the teddy bear based on the prompt modify the entire teddy bear as well as produce undesirable edits to the background. Column three illustrates results using the conventional techniques and object masking, and column four illustrates the results using the techniques described herein. As is shown in column three, the entire teddy bear displays the modification associated with the text prompt. As compared to column four, drastic improvements are possible using the techniques described herein as the area of interest (e.g., a t-shirt region) of the teddy bear displays the modifications with the hands, head, and leg portions of the teddy bear remaining unchanged. FIG. 5 demonstrates the ability to use the techniques described herein to enable drastic edits to the input scene while also significantly improving on visual quality and texture detail.

The techniques described herein may also improve the convergence rate of the edits. For example, in contrast with conventional techniques, which condition the editing of the NeRF scene on the input image, adding random amounts of noise, and slowly introducing edited images into a NeRF optimization, the present disclosure conditions the diffusion model only on the NeRF geometry (e.g., distance maps). In other words, conventional techniques must introduce individual image edits slowly into the NeRF training due to the inconsistencies in the edits, which in turn causes conventional techniques to converge much more slowly. On the contrary, the individual edits using the depth-guided text-based editing techniques described herein produce much more consistent results with a faster convergence speed. The depth-guided conditioning results in the ability to make drastic edits to the input scene while significantly improving the visual quality and texture detail. Thus, all input images may be edited simultaneously (e.g., all input images are edited at once upon execution of the scene editing system). Subsequent iterations using the techniques described by the present disclosure may then be used to finetune the quality of the output to capture the finer details associated with the text command thereby enabling the scene representation model to be trained for a large number of iterations leading to highly view-consistent results, enhanced outputs, and inclusion of finer details.

### Examples of Computing Environments for Implementing Certain Embodiments

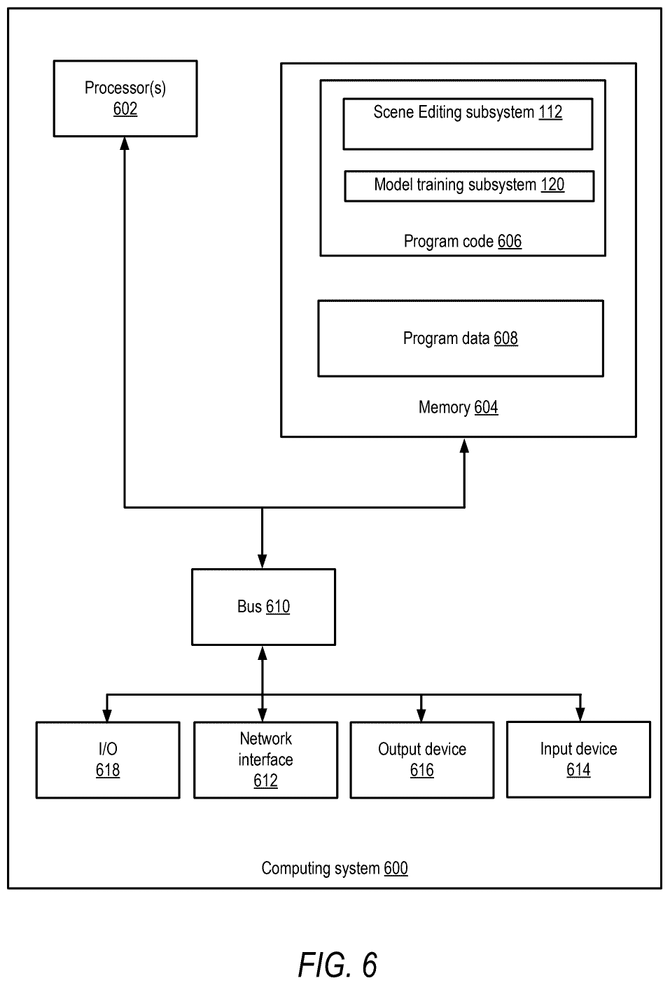

Any suitable computer system or group of computer systems can be used for performing the operations described herein. For example, FIG. 6 depicts an example of a computer system 600. The depicted example of the computer system 600 includes a processing device 602 communicatively coupled to one or more memory components 604. The processing device 602 executes computer-executable program code stored in a memory components 604, accesses information stored in the memory component 604, or both. Execution of the computer-executable program code causes the processing device to perform the operations described herein. Examples of the processing device 602 include a microprocessor, an application-specific integrated circuit (“ASIC”), a field-programmable gate array (“FPGA”), or any other suitable processing device. The processing device 602 can include any number of processing devices, including a single processing device.

The memory components 604 includes any suitable non-transitory computer-readable medium for storing program code 606, program data 608, or both. A computer-readable medium can include any electronic, optical, magnetic, or other storage device capable of providing a processing device with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript. In various examples, the memory components 604 can be volatile memory, non-volatile memory, or a combination thereof.

The computer system 600 executes program code 606 that configures the processing device 602 to perform one or more of the operations described herein. Examples of the program code 606 include, in various embodiments, the scene editing system 110 (including the scene editing subsystem 112 and the model training subsystem 120 described herein) of FIG. 1, which may include any other suitable systems or subsystems that perform one or more operations described herein (e.g., one or more neural networks, encoders, attention propagation subsystem and segmentation subsystem). The program code 606 may be resident in the memory components 604 or any suitable computer-readable medium and may be executed by the processing device 602 or any other suitable processor.

The processing device 602 is an integrated circuit device that can execute the program code 606. The program code 606 can be for executing an operating system, an application system or subsystem, or both. When executed by the processing device 602, the instructions cause the processing device 602 to perform operations of the program code 606. When being executed by the processing device 602, the instructions are stored in a system memory, possibly along with data being operated on by the instructions. The system memory can be a volatile memory storage type, such as a Random Access Memory (RAM) type. The system memory is sometimes referred to as Dynamic RAM (DRAM) though need not be implemented using a DRAM-based technology. Additionally, the system memory can be implemented using non-volatile memory types, such as flash memory.

In some embodiments, one or more memory components 604 store the program data 608 that includes one or more datasets described herein. In some embodiments, one or more of data sets are stored in the same memory component (e.g., one of the memory components 604). In additional or alternative embodiments, one or more of the programs, data sets, models, and functions described herein are stored in different memory components 604 accessible via a data network. One or more buses 610 are also included in the computer system 600. The buses 610 communicatively couple one or more components of a respective one of the computer system 600.

In some embodiments, the computer system 600 also includes a network interface device 612. The network interface device 612 includes any device or group of devices suitable for establishing a wired or wireless data connection to one or more data networks. Non-limiting examples of the network interface device 612 include an Ethernet network adapter, a modem, and/or the like. The computer system 600 is able to communicate with one or more other computing devices via a data network using the network interface device 612.

The computer system 600 may also include a number of external or internal devices, an input device 614, a presentation device 616, or other input or output devices. For example, the computer system 600 is shown with one or more input/output (“I/O”) interfaces 618. An I/O interface 618 can receive input from input devices or provide output to output devices. An input device 614 can include any device or group of devices suitable for receiving visual, auditory, or other suitable input that controls or affects the operations of the processing device 602. Non-limiting examples of the input device 614 include a touchscreen, a mouse, a keyboard, a microphone, a separate mobile computing device, etc. A presentation device 616 can include any device or group of devices suitable for providing visual, auditory, or other suitable sensory output. Non-limiting examples of the presentation device 616 include a touchscreen, a monitor, a speaker, a separate mobile computing device, etc.

Although FIG. 6 depicts the input device 614 and the presentation device 616 as being local to the computer system 600, other implementations are possible. For instance, in some embodiments, one or more of the input device 614 and the presentation device 616 can include a remote client-computing device that communicates with computing system 600 via the network interface device 612 using one or more data networks described herein.

Embodiments may comprise a computer program that embodies the functions described and illustrated herein, wherein the computer program is implemented in a computer system that comprises instructions stored in a machine-readable medium and a processing device that executes the instructions to perform applicable operations. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computer systems. Moreover, any reference to an act being performed by a computer should not be construed as being performed by a single computer as more than one computer may perform the act.

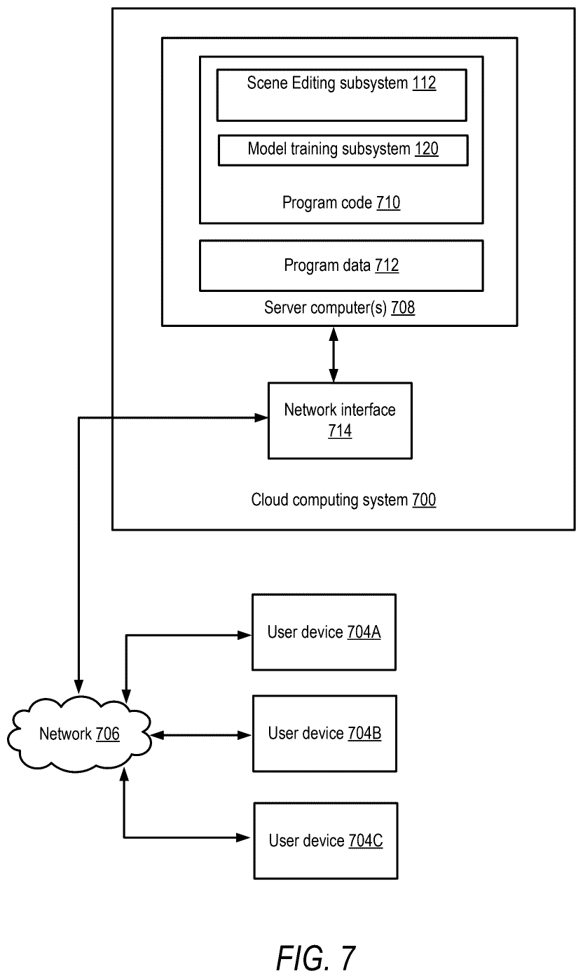

In some embodiments, the functionality provided by computer system 600 may be offered as cloud services by a cloud service provider. For example, FIG. 7 depicts an example of a cloud computer system 700 offering a service for providing a view 104 of a modified 3D scene 154 based on input images 152, that can be used by a number of user subscribers using user devices 704A, 704B, and 704C across a data network 706. In the example, the service for providing a view 104 of a modified 3D scene 154 based on input images 152 may be offered under a Software as a Service (SaaS) model. One or more users may subscribe to the service for providing a view 104 of a modified 3D scene 154 based on input images 152, and the cloud computer system 700 performs the processing to provide the service for providing a view 104 of a modified 3D scene 154 based on input images 152. The cloud computer system 700 may include one or more remote server computers 708.

The remote server computers 708 include any suitable non-transitory computer-readable medium for storing program code 710 (e.g., the scene editing subsystem 112 and the model training subsystem 120 of FIG. 1) and program data 712, or both, which is used by the cloud computer system 700 for providing the cloud services. A computer-readable medium can include any electronic, optical, magnetic, or other storage device capable of providing a processing device with executable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript. In various examples, the server computers 708 can include volatile memory, non-volatile memory, or a combination thereof.

One or more of the server computers 708 execute the program code 710 that configures one or more processing devices of the server computers 708 to perform one or more of the operations that provide views 104 of a modified 3D scene 154 based on input images 152. As depicted in the embodiment in FIG. 7, the one or more servers providing the services for providing a view 104 of a modified 3D scene 154 based on input images 152 may implement the scene editing subsystem 112 and the model training subsystem 120. Any other suitable systems or subsystems that perform one or more operations described herein (e.g., one or more development systems for configuring an interactive user interface) can also be implemented by the cloud computer system 700.

In certain embodiments, the cloud computer system 700 may implement the services by executing program code and/or using program data 712, which may be resident in a memory component of the server computers 708 or any suitable computer-readable medium and may be executed by the processing devices of the server computers 708 or any other suitable processing device.

In some embodiments, the program data 712 includes one or more datasets and models described herein. In some embodiments, one or more of data sets, models, and functions are stored in the same memory component. In additional or alternative embodiments, one or more of the programs, data sets, models, and functions described herein are stored in different memory components accessible via the data network 706.

The cloud computer system 700 also includes a network interface device 714 that enable communications to and from cloud computer system 700. In certain embodiments, the network interface device 714 includes any device or group of devices suitable for establishing a wired or wireless data connection to the data networks 706. Non-limiting examples of the network interface device 714 include an Ethernet network adapter, a modem, and/or the like. The service for providing views 104 of a modified 3D scene 154 based on input images 152 is able to communicate with the user devices 704A, 704B, and 704C via the data network 706 using the network interface device 714.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included within the scope of claimed embodiments.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

### GENERAL CONSIDERATIONS

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included within the scope of claimed embodiments.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computer system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as an open and inclusive language that does not foreclose devices adapted to or configured to perform additional tasks or steps. Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Additionally, the use of “based on” is meant to be open and inclusive, in that, a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

What is claimed is:

1. A method performed by one or more processing devices, comprising:
receiving a plurality of input two-dimensional (2D) images corresponding to a plurality of views of a target disposed in an environment, wherein each input 2D image comprises a plurality of pixels and each pixel is defined by a position and a direction associated with the view;
generating, using a scene representation model, a three-dimensional (3D) representation from the plurality of input 2D images, wherein the 3D representation comprises a plurality of points forming a point cloud and each point is defined by a color value and a density value;
accumulating, using the scene representation model, the color value and the density value of each point in the point cloud to thereby generate a volumetric 3D scene, wherein the volumetric 3D scene is defined by a geometry;
extracting, using the scene representation model, a plurality of distance maps from the volumetric 3D scene and based on the geometry, wherein each distance map is associated with an expected distance per pixel value for a view of the target in the environment;
generating a plurality of masks associated with the target for each of the plurality of views;
aggregating the plurality of masks into the volumetric 3D scene using the geometry to thereby generate a plurality of final masks;
providing the plurality of input 2D images, the plurality of final masks, and the plurality of distance maps to a diffusion model; and
modifying an appearance of the target in the volumetric 3D scene by providing a text command to the diffusion model.

2. The method of claim 1, wherein the plurality of masks comprises a plurality of initial masks each having a plurality of pixels, and wherein aggregating the plurality of masks into the volumetric 3D scene to generate the plurality of final masks further comprises:
unprojecting each pixel from each initial mask into the volumetric 3D scene using the distance maps to thereby generate a plurality of 3D mask points;
assigning to each 3D mask point, a confidence value representing a probability that the 3D mask point is within a proximity to a surface of the target within the environment;
determining that the confidence value exceeds a pre-defined visibility threshold value;
updating the point cloud of the 3D representation to include the 3D mask point to thereby generate an updated point cloud;
for each 3D mask point confidence value that exceeds the pre-defined visibility threshold, projecting the 3D mask point into the initial mask to generate an updated mask; and
filtering each of the updated masks using the plurality of input 2D images to generate the plurality of final masks associated with the target.

3. The method of claim 1, wherein the 3D representation comprises a Neural Radiance Field (NeRF) and the diffusion model comprises a denoising diffusion probabilistic model.

4. The method of claim 3, wherein the plurality of final masks defines a region of interest in the volumetric 3D scene and the denoising diffusion probabilistic model applies a series of denoising operations on the region of interest, and wherein a background region of the input 2D images outside the region of interest is copied into the input 2D images after each denoising operation.

5. The method of claim 1, wherein the scene representation model is trained on at least the plurality of input 2D images.

6. The method of claim 1, wherein the target comprises an object, a person, or an animal.

7. The method of claim 1, wherein the position and the direction associated with the view defines a location of each pixel in five dimensions, wherein the position is associated with view coordinates of the target in three dimensions and the direction is associated with a camera viewing angle in two dimensions.

8. A system comprising:
one or more processors; and
one or more memory including instructions executable by the one or more processors to cause the one or more processors to:
receive a plurality of input two-dimensional (2D) images corresponding to a plurality of views of a target disposed in an environment, wherein each input 2D image comprises a plurality of pixels and each pixel is defined by a position and a direction associated with the view;
generate, using a scene representation model, a three-dimensional (3D) representation from the plurality of input 2D images, wherein the 3D representation comprises a plurality of points forming a point cloud and each point is defined by a color value and a density value;
accumulate, using the scene representation model, the color value and the density value of each point in the point cloud to thereby generate a volumetric 3D scene, wherein the volumetric 3D scene is defined by a geometry;
extract, using the scene representation model, a plurality of distance maps from the volumetric 3D scene and based on the geometry, wherein each distance map is associated with an expected distance per pixel value for a view of the target in the environment;
generate a plurality of masks associated with the target for each of the plurality of views;
aggregate the plurality of masks into the volumetric 3D scene using the geometry to thereby generate a plurality of final masks;
provide the plurality of input 2D images, the plurality of final masks, and the plurality of distance maps to a diffusion model; and
modify an appearance of the target in the volumetric 3D scene by providing a text command to the diffusion model.

9. The system of claim 8, wherein the plurality of masks comprises a plurality of initial masks each having a plurality of pixels, and wherein the instructions are further executable by the one or more processors to cause the one or more processors to:
unproject each pixel from each initial mask into the volumetric 3D scene using the distance maps to thereby generate a plurality of 3D mask points;
assign to each 3D mask point, a confidence value representing a probability that the 3D mask point is within a proximity to a surface of the target within the environment;
determine that the confidence value exceeds a pre-defined visibility threshold value;
update the point cloud of the 3D representation to include the 3D mask point to thereby generate an updated point cloud;
for each 3D mask point confidence value that exceeds the pre-defined visibility threshold, project the 3D mask point into the initial mask to generate an updated mask; and
filter each of the updated masks using the plurality of input 2D images to generate the plurality of final masks associated with the target.

10. The system of claim 8, wherein the 3D representation comprises a Neural Radiance Field (NeRF) and the diffusion model comprises a denoising diffusion probabilistic model.

11. The system of claim 10, wherein the plurality of final masks defines a region of interest in the volumetric 3D scene and the denoising diffusion probabilistic model applies a series of denoising operations on the region of interest, and wherein a background region of the input 2D images outside the region of interest is copied into the input 2D images after each denoising operation.

12. The system of claim 8, wherein the scene representation model is trained on at least the plurality of input 2D images.

13. The system of claim 8, wherein the target comprises an object, a person, or an animal.

14. The system of claim 8, wherein the position and the direction associated with the view defines a location of each pixel in five dimensions, wherein the position is associated with view coordinates of the target in three dimensions and the direction is associated with a camera viewing angle in two dimensions.

15. A non-transitory computer-readable medium storing instructions that, when executed by one or more processors, cause the one or more processors to perform operations including:
receive a plurality of input two-dimensional (2D) images corresponding to a plurality of views of a target disposed in an environment, wherein each input 2D image comprises a plurality of pixels and each pixel is defined by a position and a direction associated with the view;
generate, using a scene representation model, a three-dimensional (3D) representation from the plurality of input 2D images, wherein the 3D representation comprises a plurality of points forming a point cloud and each point is defined by a color value and a density value;
accumulate, using the scene representation model, the color value and the density value of each point in the point cloud to thereby generate a volumetric 3D scene, wherein the volumetric 3D scene is defined by a geometry;
extract, using the scene representation model, a plurality of distance maps from the volumetric 3D scene and based on the geometry, wherein each distance map is associated with an expected distance per pixel value for a view of the target in the environment;
generate a plurality of masks associated with the target for each of the plurality of views;
aggregate the plurality of masks into the volumetric 3D scene using the geometry to thereby generate a plurality of final masks;
provide the plurality of input 2D images, the plurality of final masks, and the plurality of distance maps to a diffusion model; and
modify an appearance of the target in the volumetric 3D scene by providing a text command to the diffusion model.

16. The non-transitory computer-readable medium of claim 15, wherein the plurality of masks comprises a plurality of initial masks each having a plurality of pixels, and further comprising program code that is executable by the processor to cause the processor to:
unproject each pixel from each initial mask into the volumetric 3D scene using the distance maps to thereby generate a plurality of 3D mask points;
assign to each 3D mask point, a confidence value representing a probability that the 3D mask point is within a proximity to a surface of the target within the environment;
determine that the confidence value exceeds a pre-defined visibility threshold value;
update the point cloud of the 3D representation to include the 3D mask point to thereby generate an updated point cloud;
for each 3D mask point confidence value that exceeds the pre-defined visibility threshold, project the 3D mask point into the initial mask to generate an updated mask; and
filter each of the updated masks using the plurality of input 2D images to generate the plurality of final masks associated with the target.

17. The non-transitory computer-readable medium of claim 15, wherein the 3D representation comprises a Neural Radiance Field (NeRF) and the diffusion model comprises a denoising diffusion probabilistic model.

18. The non-transitory computer-readable medium of claim 17, wherein the plurality of final masks defines a region of interest in the volumetric 3D scene and the denoising diffusion probabilistic model applies a series of denoising operations on the region of interest, and wherein a background region of the input 2D images outside the region of interest is copied into the input 2D images after each denoising operation.

19. The non-transitory computer-readable medium of claim 15, wherein the scene representation model is trained on at least the plurality of input 2D images, and wherein the target comprises an object, a person, or an animal.

20. The non-transitory computer-readable medium of claim 15, wherein the position and the direction associated with the view defines a location of each pixel in five dimensions, wherein the position is associated with view coordinates of the target in three dimensions and the direction is associated with a camera viewing angle in two dimensions.
